(19) United States
(12) Patent Application Publication
(10) Pub. No.: US 2016/0078533 A1
(43) Pub. Date: Mar. 17, 2016

(54) Mortgage assistant method

(71) Applicant: Bijan Dokhanian, Beverly Hills, CA (US)

(72) Inventors: Bijan Dokhanian, Beverly Hills, CA (US); Zoltan Kemeny, Chandler, AZ (US); Demis Dokhanian, Beverly Hills, CA (US); Diamo Dokhanian, Beverly Hills, CA (US)

(21) Appl. No.: 14/756,759

(22) Filed: Oct. 8, 2015

(51) Int. Cl. G06Q 40/02; G06Q 50/16

(52) U.S. Cl. CPC G06Q 40/025; G06Q 50/16

(57) ABSTRACT

Disclosed is four new financing methods, one of which involves financing of a set portion, say 50%, of a mortgage secured by junior lien on the property for say 10 years, and offering the option to mortgagee of buying out the lender once a year, say by any year ends, for the repayment of the loan plus say 1% of the property fair value, whereas mortgagee and lender may form a joint venture, in which lender may buy life insurance on the mortgagee, to clear obligations, should mortgagee pass away, in which case the lender, as sole beneficiary receives the policy benefit. The other three, are novel modifications of the same, yielding to novel financing methods, all aiming to help distressed property owners to keep their property in hardship.

### FIELD OF THE INVENTION

This invention relates to innovative third party financing of mortgage payments, in part or in full, by a lender with secured interest in the property.

### BACKGROUND OF THE INVENTION

The invention fulfills the need for loaning midterm to pay part of a mortgage payment, including property tax and insurance, having the loan secured by a lien on the property, and allowing the mortgagee to buy out the lender any year end for the loaned amount plus a minor percentage of the mortgage face value, whereas the lender may form joint venture with the mortgagee and secure the investment with a life insurance on the mortgagee with the lender named as beneficiary, while the deal may be securitized and traded.

To buy a house (or any Owner Occupied or Income Property) via mortgage, the to-be-owner need to pay 3-33% downpayment of the mortgage face value, which typically the purchase price of the property plus some financing charges. Some people could afford the downpayment but would not warrant the stream of the monthly payments for years as needed. Thus, lacking a third party help, they abstain from the purchase, though over time, they expect regaining financial strength enough to own the mortgage completely.

It is well known that the real estate market is cyclical. This invention allows a large segment of the population to enter the real estate market when property prices, interest rates and cost of financing are low.

It is the object of the invention to offer fair assistance to such people via landing the mortgage payment secured.

Also, to incentivize the mortgagee to pay back the loan as soon as possible and to allow for fair gains to the lender, who could securitize the deal.

Finally, to allow for lender-mortgagee joint partnership/venture for complete mortgage payment take over by the lender and secure it by life insurance policy on the mortgagee's life with the lender named as beneficiary.

Such mortgage assistance would allow a significant segment of the population to appear on the real estate market as buyers on credit. The elderly and the young would greatly benefit from such financial help.

### SUMMARY OF THE INVENTION

The above problems and others are at least partially solved and the above objects and others realized in a process, which according to the teachings of this invention, uses four basic methods, one of which, the 1^{st} one, or Method 1, and consists of steps including:
A. Mortgagee paying downpayment to the property, which should equal to no less than 30% of the property purchase price unless otherwise is agreed to by lender in writing;
B. Mortgagee pays 50% of the monthly mortgage payments, Including Property Taxes and Insurance;
C. Lender pays 50% of the monthly mortgage payments for 10 years, Including Property Taxes and Insurance;
D. Lender secures a 10-year lien on the property;
E. By year ends, Mortgagee can buy out Lender by paying in full the loaned amount plus 1% of the mortgaged property face value per year since funding;
F. Upon said buyout, Mortgagee keep paying 100% of the mortgage payments and Lender removes the lean;
G. In lieu of said buyout, upon the maturity of the loan, at the end of the 10^{th} year, mortgagee is liable to pay the loan in a lump sum balloon payment;
H. If the loan is not paid back in full with interest, lender may grant one more year extension, maximum three times, with the same terms and conditions at Lender's option,
   where the numbers, except the 100%, are exemplary for process illustration only.

The 2^{nd} one, or Method 2, consists of steps including:
A. Buyer and Lender form a 50/50% monetary Partnership and become Partners;
B. Buyer pays 100% downpayment of the mortgage, which shall not be less than 30% of the property purchase price or property fair market value appraised by Lender;
C. Lender pays 100% of the monthly mortgage payment, plus the property taxes and the property insurance;
D. Lender buys Life Insurance on the property owner's life in face value equal or higher than 5× the property value with Lender as the sole beneficiary of the policy;
E. Upon the death of the Buyer, the property owner, Lender pays the received life insurance policy benefits towards the balance of the mortgage, while all the money that the lender has paid to date plus interest should also be paid in full;
F. Upon shortage, Lender keep paying the mortgage until it is paid in full,
G. Upon excess, the excess is owned 50/50% in said Partnership, which partnership is now owned by the heir(s) of the Buyer which now is called New Partner(s);
H. Both Partners may exercise their options to buy out the other;
I. In case, New Partner(s) buy(s) out Lender, he must pay all the money Lender paid thus far, plus 50% of the property equity if any;
J. In case Lender buys out Buyer, he must pay fair market value,
   where the numbers, except the 100%, are exemplary for process illustration only.

The 3^{rd} one, or Method 3, consists of steps including:
A. Two Buyers, say a married couple with equal shares between them, commonly, and Lender form a 50/50% monetary partnership and become Partners;
B. Buyer pays 100% downpayment of the mortgage, which shall not be less than 30% of the purchase price of the property or otherwise agreed upon in writing;
C. Lender pays 100% of the monthly mortgage payment, plus the property taxes and the property insurance;
D. Buyer buys life insurance on each of the property owners' life in face value equal or higher than 2.5× the property value with Lander as the sole beneficiary of the policy;
E. Upon the death of the 1^{st} Buyer, Lender pays the received life insurance policy benefits towards the balance of the mortgage and the payments paid to date by lender including property taxes and insurance plus 1% per year of the mortgage face value;
F. Upon shortage, Lender keeps paying the mortgage until it is paid in full;
G. Upon excess, the excess is owned 50/50% in said partnership, now between Lender and 2^{nd} Buyer as first survivor;
H. Both Partners may exercise their options to buy out the other;
I. In case, 2^{nd} Buyer buys out Lender, he must pay all the money Lender paid thus far;
J. In case Lender buys out 2^{nd} Buyer, he must pay fair market value,
K. Upon the death of the last and 2^{nd} Buyer, Lender pays the received life insurance policy benefits towards the balance of the mortgage, if any;
L. Upon shortage, Lender keeps paying the mortgage until it is paid in full,
M. Upon excess, the excess is owned 50/50% in said partnership, now between Lender and the Heirs of the 2^{nd} Buyer, who now became Partners in said Partnership;
N. Both Partners, Lender solely and Heirs commonly, may exercise their options to buy out the other at fair market value,
   where the numbers, except the 100%, are exemplary for process illustration only.

The money owed to lender any time is all payments paid by lender for mortgage, property tax and insurance plus 1% per year of mortgage face value plus 50% of property equity if any.

The 4^{th} one, or Method 4, consists of steps including:
A. Buyer pay 100% of the downpayment to purchase of the property which should be no less than 30% of the purchase price or as otherwise agreed by lender in writing;
B. Buyer pay 100% of all mortgage payments of his mortgage, including property taxes and property insurance;
C. Lender sells a membership fee of about $150/month per every million dollars of mortgaged amount to buyer to become member of the Lender Program against foreclosure due to reasons such as loss or decrease in income, divorce, health issues and or other incapacitating matters in the future;
D. Lender at its option may ask buyer to take a loan from lender to purchase a life insurance equal to 2× value of the property and name the lender its sole beneficiary, whereas the premium for such policy will be paid and funded in full by lender and does not need to be paid until the buyer passes, while, to avoid any misuse of this fund, monthly payment for that life insurance will be paid directly by lender;
E. If Buyer, for any reason experiences financial or personal hardship any time before the mortgage is paid off in full and fails to make mortgage payments, property taxes and property insurance payments and is past due for more than 90 days, Lender will automatically pay such payments in behalf of the Buyer, up to 60 payments;
F. Lender warrants the first 12 payments, covering the 1^{st} year thereof and optionally the payments of the 2^{nd}, 3^{rd}, 4^{th} and 5^{th} years decided year-by-year at his discretion;
G. The cost of the loan thereof is all the amount paid by Lender in behalf of Buyer, plus 2% of the face value of the 1^{st} deed of trust per year, which is secured by the property;
H. Buyers must agree to take a loan from lender to purchase a life insurance policy equal to 2× (or other values approved by lender) value of the property and name lender as the sole beneficiary.
I. If Buyer buys out Lender by paying all the money the Lender advanced in behalf of the Buyer, Lender still remains the sole beneficiary of said life insurance, but the lien on the property will be removed and the partnership dissolved,
   where the numbers, except the 100%, are exemplary for process illustration only.

Mortgagee can be a single person or a couple or other persons (an Entity). Lender can also be a single person or entity or a group of investors (Lenders). The deal between Lander(s) and Mortgagee or Buyer(s) can be traded and securitized.

Said buy out must include the balance of the mortgage, plus property taxes and property insurance, as well as incidentals, including, title, escrow and clerical fees.

Where the rules call for Buyer, mortgagee or Lender, Buyers, mortgagees and Lenders are meant to follow the same rules as groups.

### BRIEF DESCRIPTION OF THE DRAWINGS

Referring to the drawings:

FIG. 1 is a diagram illustrating Method 1.

FIG. 2 is a diagram illustrating Method 2.

FIG. 3 is a diagram illustrating Method 3.

FIG. 4 is a diagram illustrating Method 4.

### DETAILED DESCRIPTION OF A PREFERRED EMBODIMENT

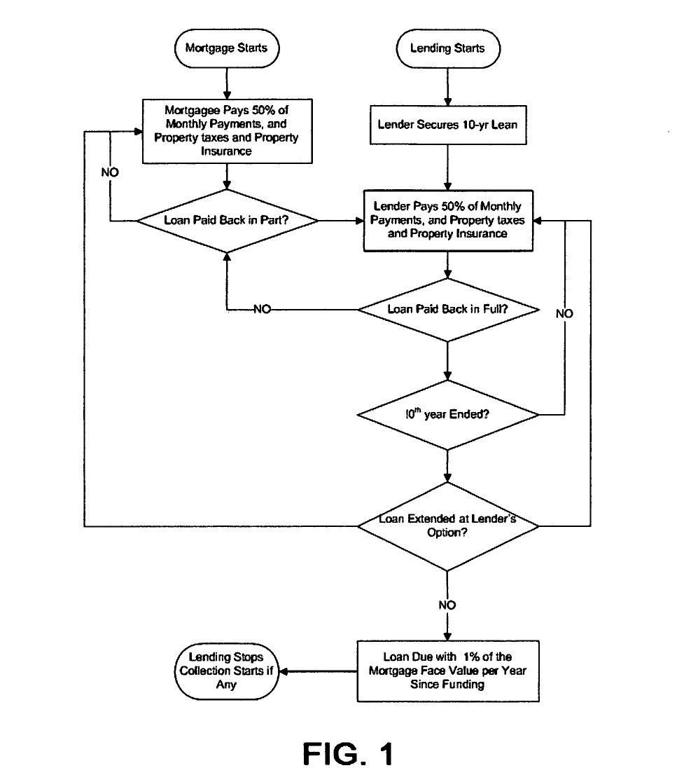

Attention is now turned to FIG. 1, which illustrates a diagram detailing the steps and their relationship of Method 1 as specified above.

This method is suitable for homebuyers of insufficient funds to pay a desired mortgage for several years to come, yet having reasonable expectation that their financial strength will be regained in 5-10 years and thus are willing to pay some more by that time, rather than losing the opportunity now to own and live in a desirable property now and pay only a limited amount monthly towards.

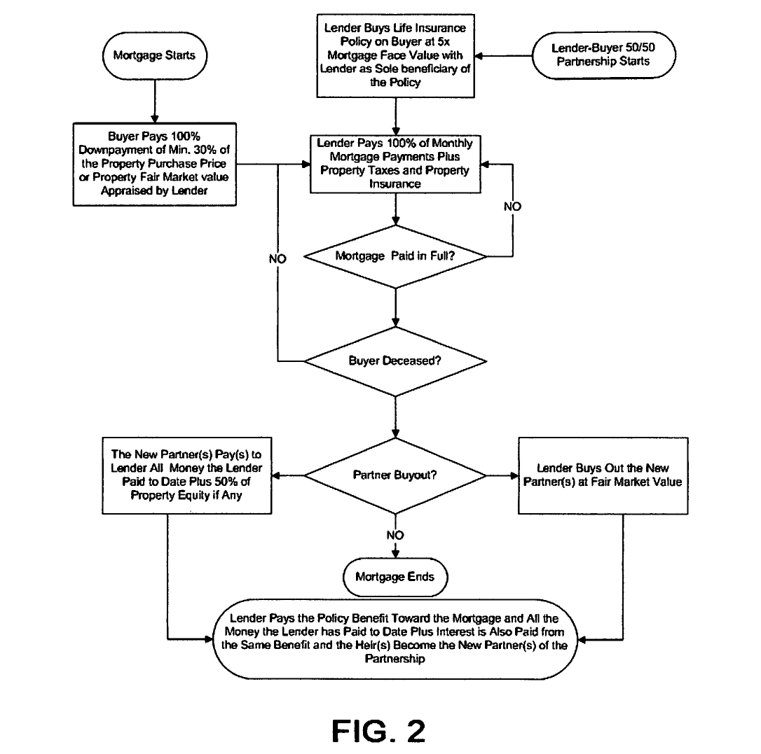

Attention is now turned to FIG. 2, which illustrates a diagram detailing the steps and their relationship of Method 2 as specified above.

This method is suitable for homebuyers of insufficient funds to pay even a small amount of monthly mortgage payment, but the downpayment from their savings, for they also expect to regain financial strength, though unsure when, by which time, they would be ready to buy out a lender, who lends the mortgage payment and the incidental expenses in their behalf.

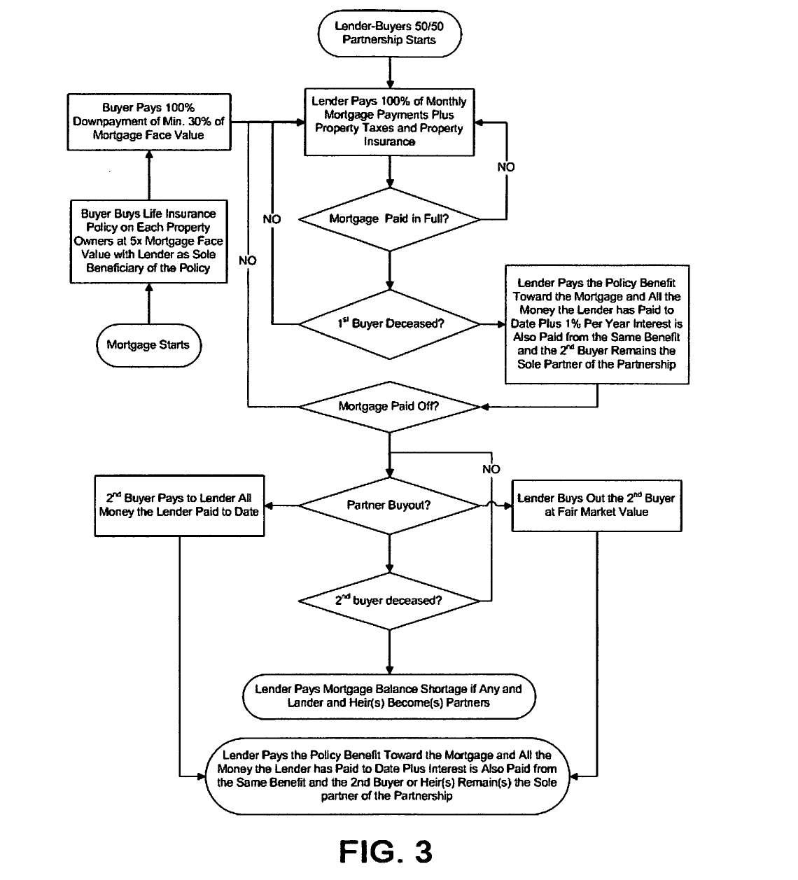

Attention is now turned to FIG. 3, which illustrates a diagram detailing the steps and their relationship of Method 3 as specified above.

This method is suitable for homebuyers of insufficient funds described above for FIG. 2, whereas said homebuyers are a married couple or have similar relationship, including civil union, both of which may pass away in succession, while their life insurance would assure the lender against losses.

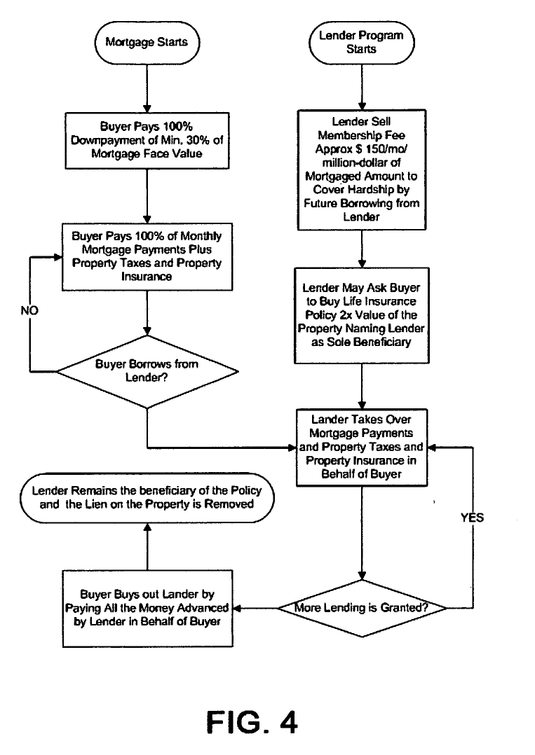

Attention is now turned to FIG. 4, which illustrates a diagram detailing the steps and their relationship of Method 4 as specified above.

This method is suitable for homebuyers of insufficient funds described above for FIG. 3, whereas said homebuyers would pay monthly a nominal sum for the assurance that, should they fall on hard time years later, they will not lose their home or/as income property before they regain financial strength year later.

The present invention is described above with reference to a preferred embodiment. However, those skilled in the art will recognize that changes and modifications may be made in the described embodiment without departing from the nature and scope of the present invention. For instance, should said loan balance increase year-by-year, so should increase the lean securing it. Such continuous accumulation of obligation is considered an obvious modification and thus being within the scope of the invention.

Various further changes and modifications to the embodiment herein chosen for purposes of illustration will readily occur to those skilled in the art. To the extent that such modifications and variations do not depart from the spirit of the invention, they are intended to be included within the scope thereof.

Having fully described the invention in such clear and concise terms as to enable those skilled in the art to understand and practice the same, the invention claimed is:

1. Mortgage financing method as specified in reference to FIG. 1, whereas said figures are merely exemplary, said payments include incidentals, and said deal is tradable.

2. Method as per claim 1, whereas said entities are all single entities.

3. Method as per claim 1, whereas said entities are all multiple entities.

4. Method as per claim 1, whereas at least one of said entities are all single entities.

5. Method as per claim 1, whereas at least one of said entities are multiple entities.

6. Mortgage financing method as specified in reference to FIG. 2, whereas said figures are merely exemplary, said payments include incidentals, and said deal is tradable.

7. Method as per claim 6, whereas said entities are all single entities.

8. Method as per claim 6, whereas said entities are all multiple entities.

9. Method as per claim 6, whereas at least one of said entities are all single entities.

10. Method as per claim 6, whereas at least one of said entities are multiple entities.

11. Mortgage financing method as specified in reference to FIG. 3, whereas said figures are merely exemplary, said payments include incidentals, and said deal is tradable.

12. Method as per claim 11, whereas said entities are all single entities.

13. Method as per claim 11, whereas said entities are all multiple entities.

14. Method as per claim 11, whereas at least one of said entities are all single entities.

15. Method as per claim 11, whereas at least one of said entities are multiple entities.

16. Mortgage financing method as specified in reference to FIG. 4, whereas said figures are merely exemplary, said payments include incidentals, and said deal is tradable.

17. Method as per claim 16, whereas said entities are all single entities.

18. Method as per claim 16, whereas said entities are all multiple entities.

19. Method as per claim 16, whereas at least one of said entities are all single entities.

20. Method as per claim 16, whereas at least one of said entities are multiple entities.
